(19) United States
(12) Patent Application Publication
(10) Pub. No.: US 2020/0311525 A1
(43) Pub. Date: Oct. 1, 2020

(54) BIAS CORRECTION IN DEEP LEARNING SYSTEMS

(71) Applicant: International Business Machines Corporation, Armonk, NY (US)

(72) Inventors: Tal Kachman, Haifa (IL); John A. Gunnels, Somers, NY (US); Catherine H. Crawford, Bedford, NH (US); Lior Horesh, North Salem, NY (US)

(73) Assignee: International Business Machines Corporation, Armonk, NY (US)

(21) Appl. No.: 16/372,136

(22) Filed: Apr. 1, 2019

(51) Int. Cl. G06N 3/063; G06N 3/08; G06F 16/28

(52) U.S. Cl. CPC G06N 3/063; G06F 16/285; G06N 3/08

(57) ABSTRACT

In an embodiment, a method includes classifying, using a neural network including quantum components, a data set to generate a first set of classified data. In the embodiment, the method includes generating noise in the quantum components. In the embodiment, the method includes reclassifying, using the neural network, the data set with the generated noise to generate a second set of classified data. In the embodiment, the method includes determining, responsive to comparing the first set of classified data and the second set of classified data, a sensitivity of the quantum components.

### TECHNICAL FIELD

The present invention relates generally to machine learning. More particularly, the present invention relates to bias correction in deep learning systems.

### BACKGROUND

A neural network is an artificial neural network (ANN) modeled after the functioning of the human brain, with weighted connections among its nodes, or “neurons.” A deep neural network (DNN) is an artificial neural network with multiple “hidden” layers between its input and output layers. The hidden layers of a DNN allow it to model complex nonlinear relationships featuring higher abstract representations of data, with each hidden layer determining a non-linear transformation of a prior layer.

The neural network model is typically trained through numerous iterations over vast amounts of data. As a result, training a DNN can be very time-consuming and computationally expensive. For example, in training DNNs to correctly identify faces, thousands of photographs of faces (of people, animals, famous faces, and so on) are input into the system. This is the training data. The DNN processes each photograph using weights from the hidden layers, comparing the training output against the desired output. A goal is that the training output matches the desired output, e.g., for the neural network to correctly identify each photo (facial recognition).

When the error rate is sufficiently small (e.g., the desired level of matching occurs), the neural network can be said to have reached “convergence.” In some situations, convergence means that the training error is zero, while in other situations, convergence can be said to have been reached when the training error is within an acceptable threshold. The system begins with a high error rate, as high as 100% in some cases. Errors (e.g., incorrect identifications) get propagated back for further processing, often through multiple iterations, with the system continually updating the weights. The number of iterations increases with the sample size, with neural networks today running in excess of 100,000 iterations.

Hereinafter, a “Q” prefix in a word of phrase is indicative of a reference of that word or phrase in a quantum computing context unless expressly distinguished where used.

Molecules and subatomic particles follow the laws of quantum mechanics, a branch of physics that explores how the physical world works at the most fundamental levels. At this level, particles behave in strange ways, taking on more than one state at the same time, and interacting with other particles that are very far away. Quantum computing harnesses these quantum phenomena to process information.

The computers we commonly use today are known as classical computers (also referred to herein as “conventional” computers or conventional nodes, or “CN”). A conventional computer uses a conventional processor fabricated using semiconductor materials and technology, a semiconductor memory, and a magnetic or solid-state storage device, in what is known as a Von Neumann architecture. Particularly, the processors in conventional computers are binary processors, i.e., operating on binary data represented by 1 and 0.

A quantum processor (q-processor) uses the unique nature of entangled qubit devices (compactly referred to herein as “qubit,” plural “qubits”) to perform computational tasks. In the particular realms where quantum mechanics operates, particles of matter can exist in multiple states—such as an “on” state, an “off” state, and both “on” and “off” states simultaneously. Where binary computing using semiconductor processors is limited to using just the on and off states (equivalent to 1 and 0 in binary code), a quantum processor harnesses these quantum states of matter to output signals that are usable in data computing.

Conventional computers encode information in bits. Each bit can take the value of 1 or 0. These 1s and 0s act as on/off switches that ultimately drive computer functions. Quantum computers, on the other hand, are based on qubits, which operate according to two key principles of quantum physics: superposition and entanglement. Superposition means that each qubit can represent both a 1 and a 0 inference between possible outcomes for an event. Entanglement means that qubits in a superposition can be correlated with each other in a non-classical way; that is, the state of one (whether it is a 1 or a 0 or both) can depend on the state of another, and that there is more information contained within the two qubits when they are entangled than as two individual qubits.

Using these two principles, qubits operate as processors of information, enabling quantum computers to function in ways that allow them to solve certain difficult problems that are intractable using conventional computers.

In machine learning, a classifier algorithm classifies data into categories. Typically, a set of training examples are each marked as belonging to a category, and a classifier training algorithm builds a model that assigns new examples to a particular category.

The illustrative embodiment recognizes that a quantum decision making system, such as a quantum classifier, a quantum regressor, a quantum controller or a quantum predictor, may be used to analyze input data and make a decision regarding the input data by a quantum classifier. For example, a quantum classifier, such as a quantum support vector machine (QSVM), may be used to analyze input data and determine a discrete classification of the input data by a quantum processor. In other examples, a regressors, controllers, or predictors may operate on continuous space entities. A quantum classifier, such as a QSVM, implements a classifier using a quantum processor which has the capability to increase the speed of classification of certain input data. The illustrative embodiments recognize that training a quantum classifier and other quantum decision making systems typically require a large sample of input data.

The illustrative embodiments recognize that training data sets can have an inherent bias. Bias affects the accuracy of the predictions of a machine learning algorithm. High bias means the predictions will be inaccurate. Bias is the tendency of a machine learning algorithm to learn an incorrect correlation from a training data set.

The illustrative embodiments recognize that several presently available techniques provide for examining sensitivity of a component of a machine learning algorithm. The sensitivity of a component of a machine learning algorithm measures the proportion of actual positives that are correctly identified. One such technique involves increasing noise. Noise is a random data set introduced to the training model. Classical noise can contain inherent bias due to the random nature of the noise.

The illustrative embodiments recognize that quantum devices, such as quantum processors, produce noise which can be tuned in intensity at a fine granularity. The quantum noise is tuned by lengthening pulses that define quantum gates and changing the amplitude of the pulses. The illustrative embodiments further recognize that quantum noise does not suffer from bias as the quantum noise is generated due to physical properties of the quantum device.

### SUMMARY

The illustrative embodiments provide a method, system, and computer program product for correcting bias in deep learning systems. In an embodiment, the method includes classifying, using a neural network including quantum components, a data set to generate a first set of classified data. In an embodiment, the method includes generating noise in the quantum components.

In an embodiment, the method includes reclassifying, using the neural network, the data set with the generated noise to generate a second set of classified data. In an embodiment, the method includes determining, responsive to comparing the first set of classified data and the second set of classified data, a sensitivity of the quantum components.

In an embodiment, the method includes adjusting a weight of the quantum components. In an embodiment, the method includes reclassifying, using the neural network, the data set to generate a third set of classified data.

In an embodiment, the method includes determining, responsive to comparing the second set of classified data and the third set of classified data, a sensitivity of the quantum components. In an embodiment, each classification of the second set of classified data matches each classification of the third set of classified data for each corresponding data item.

In an embodiment, the method includes altering an amplitude of a microwave pulse in a quantum processor. In an embodiment, the method includes lengthening pulses in a quantum processor.

An embodiment includes a computer usable program product. The computer usable program product includes a computer-readable storage device, and program instructions stored on the storage device.

In an embodiment, the program instructions are stored in a computer readable storage device in a data processing system, and wherein the computer usable code is transferred over a network from a remote data processing system. In an embodiment, the program instructions are stored in a computer readable storage device in a server data processing system, and wherein the computer usable code is downloaded over a network to a remote data processing system for use in a computer readable storage device associated with the remote data processing system.

An embodiment includes a computer system. The computer system includes a quantum processor, a computer-readable memory, and a computer-readable storage device, and program instructions stored on the storage device for execution by the quantum processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a qubit for use in a quantum processor in accordance with an illustrative embodiment;

FIG. 4 depicts a block diagram of an example hybrid quantum/classical system for correcting bias in accordance with an illustrative embodiment; and

FIG. 5 depicts a block diagram of an example configuration in accordance with an illustrative embodiment;

FIG. 6 depicts a block diagram of an example configuration in accordance with an illustrative embodiment; and

FIG. 7 depicts a flowchart of an example process in accordance with an illustrative embodiment.

### DETAILED DESCRIPTION

The illustrative embodiments used to describe the invention generally address and solve the above-described problem of bias correction using quantum computing. The illustrative embodiments provide a method and system for bias correction in deep learning systems using a hybrid classical-quantum computing system.

An embodiment provides a method for bias correction of deep learning systems using hybrid classical-quantum computing system. Another embodiment provides a conventional or quantum computer usable program product comprising a computer-readable storage device, and program instructions stored on the storage device, the stored program instructions comprising a method for bias correction in deep learning systems using hybrid classical-quantum computing system. The instructions are executable using a conventional or quantum processor. Another embodiment provides a computer system comprising a conventional or quantum processor, a computer-readable memory, and a computer-readable storage device, and program instructions stored on the storage device for execution by the processor via the memory, the stored program instructions comprising a method for bias correction in deep learning systems using hybrid classical-quantum computing system.

One or more embodiments provide for a mixed classical and quantum methodology that corrects bias in a deep learning system. In one or more embodiments, data is fed into a deep neural network to output a result. In an embodiment, the deep neural network is evaluated to determine an overall sensitivity of the network to different parameters.

In an embodiment, the sensitivity of a component of the deep neural network is evaluated by increasing noise. In the embodiment, the noise is quantum noise generated by a quantum processor. In the embodiment, the quantum noise is configured to be tunable. In the embodiment, the quantum noise is generated by lengthening a microwave pulse on the quantum processor. In the embodiment, the quantum noise is generated by altering a physical property of a microwave pulse on the quantum processor. In particular embodiments, the quantum noise is generated by altering an amplitude of a microwave pulse on the quantum processor. In an embodiment, noise is generated at an individual node level.

Accordingly, one or more embodiments provide for a system and method that enables for bias correction. Various embodiments provide for a classical/quantum methodology that corrects bias in a deep learning system.

For the clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or component that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for automatic quantum searching of object databases using a variety of components that can be purposed or repurposed to provide a described function within a data processing environment, and such adaptations are contemplated within the scope of the illustrative embodiments.

The illustrative embodiments are described with respect to certain types of steps, applications, quantum logic gates, and data processing environments only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

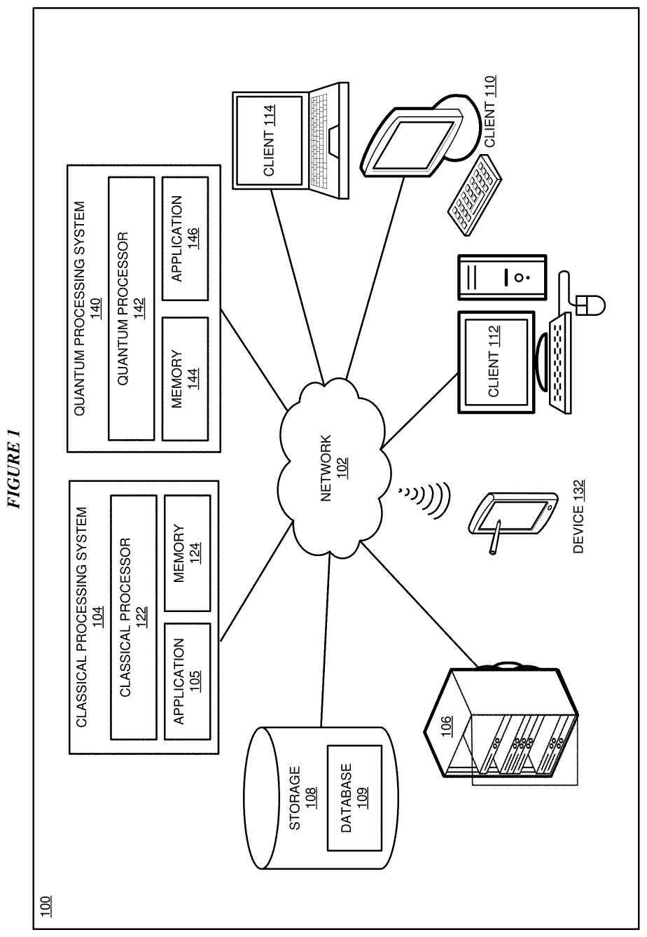

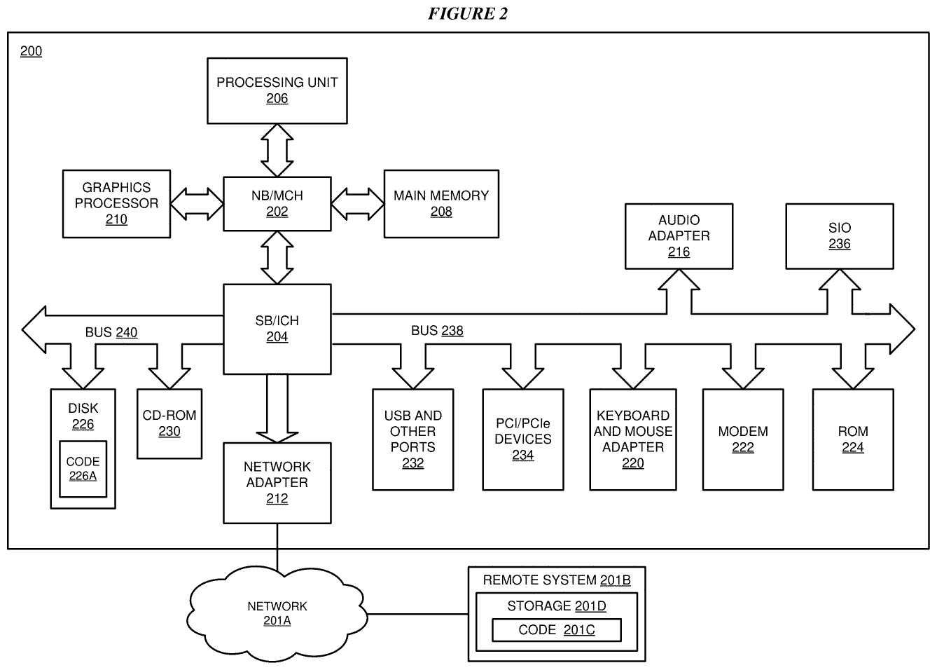

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Classical processing system 104 couples to network 102. Classical processing system 104 is a classical processing system. Software applications may execute on any quantum data processing system in data processing environment 100. Any software application described as executing in classical processing system 104 in FIG. 1 can be configured to execute in another data processing system in a similar manner. Any data or information stored or produced in classical processing system 104 in FIG. 1 can be configured to be stored or produced in another data processing system in a similar manner. A classical data processing system, such as classical processing system 104, may contain data and may have software applications or software tools executing classical computing processes thereon.

Server 106 couples to network 102 along with storage unit 108. Storage unit 108 includes a database 109 configured to store neural network training data as described herein with respect to various embodiments. Server 106 is a conventional data processing system. Quantum processing system 140 couples to network 102. Quantum processing system 140 is a quantum data processing system. Software applications may execute on any quantum data processing system in data processing environment 100. Any software application described as executing in quantum processing system 140 in FIG. 1 can be configured to execute in another quantum data processing system in a similar manner. Any data or information stored or produced in quantum processing system 140 in FIG. 1 can be configured to be stored or produced in another quantum data processing system in a similar manner. A quantum data processing system, such as quantum processing system 140, may contain data and may have software applications or software tools executing quantum computing processes thereon.

Clients 110, 112, and 114 are also coupled to network 102. A conventional data processing system, such as server 106, or client 110, 112, or 114 may contain data and may have software applications or software tools executing conventional computing processes thereon.

Only as an example, and without implying any limitation to such architecture, FIG. 1 depicts certain components that are usable in an example implementation of an embodiment. For example, server 106, and clients 110, 112, 114, are depicted as servers and clients only as example and not to imply a limitation to a client-server architecture. As another example, an embodiment can be distributed across several conventional data processing systems, quantum data processing systems, and a data network as shown, whereas another embodiment can be implemented on a single conventional data processing system or single quantum data processing system within the scope of the illustrative embodiments. Conventional data processing systems 106, 110, 112, and 114 also represent example nodes in a cluster, partitions, and other configurations suitable for implementing an embodiment.

Device 132 is an example of a conventional computing device described herein. For example, device 132 can take the form of a smartphone, a tablet computer, a laptop computer, client 110 in a stationary or a portable form, a wearable computing device, or any other suitable device. Any software application described as executing in another conventional data processing system in FIG. 1 can be configured to execute in device 132 in a similar manner. Any data or information stored or produced in another conventional data processing system in FIG. 1 can be configured to be stored or produced in device 132 in a similar manner.

Server 106, storage unit 108, classical processing system 104, quantum processing system 140, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 106 may provide data, such as boot files, operating system images, and applications to clients 110, 112, and 114. Clients 110, 112, and 114 may be clients to server 106 in this example. Clients 110, 112, 114, or some combination thereof, may include their own data, boot files, operating system images, and applications. Data processing environment 100 may include additional servers, clients, and other devices that are not shown.

In the depicted example, memory 124 may provide data, such as boot files, operating system images, and applications to classical processor 122. Classical processor 122 may include its own data, boot files, operating system images, and applications. Data processing environment 100 may include additional memories, quantum processors, and other devices that are not shown. Memory 124 includes application 105 that may be configured to implement one or more of the classical processor functions described herein for correcting bias on a hybrid classical-quantum computing system in accordance with one or more embodiments.

In the depicted example, memory 144 may provide data, such as boot files, operating system images, and applications to quantum processor 142. Quantum processor 142 may include its own data, boot files, operating system images, and applications. Data processing environment 100 may include additional memories, quantum processors, and other devices that are not shown. Memory 144 includes application 146 that may be configured to implement one or more of the quantum processor functions described herein in accordance with one or more embodiments.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a conventional client data processing system and a conventional server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a conventional computer, such as classical processing system 104, server 106, or clients 110, 112, and 114 in FIG. 1, or another type of device in which computer usable program code or instructions implementing the processes may be located for the illustrative embodiments.

Data processing system 200 is also representative of a conventional data processing system or a configuration therein, such as conventional data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

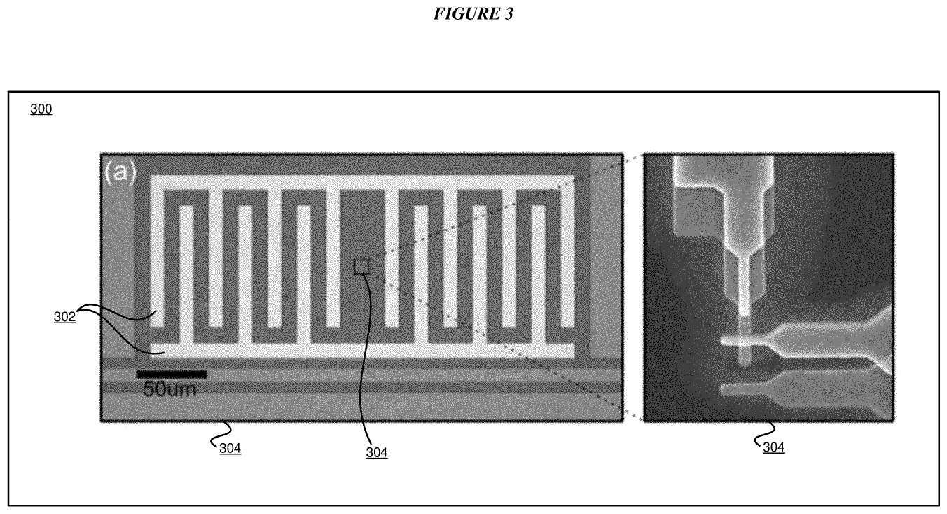

With reference to FIG. 3, this figure depicts a qubit for use in a quantum processor (e.g., quantum processor 148 in FIG. 1). Qubit 300 includes capacitor structure 302 and Josephson junction 304. Josephson junction 304 is formed by separating two thin-film superconducting metal layers by a non-superconducting material. When the metal in the superconducting layers is caused to become superconducting—e.g. by reducing the temperature of the metal to a specified cryogenic temperature-pairs of electrons can tunnel from one superconducting layer through the non-superconducting layer to the other superconducting layer. In the superconducting qubit 300, the Josephson junction 304—which has a small inductance—is electrically coupled in parallel to capacitor structure 302, forming a nonlinear resonator.

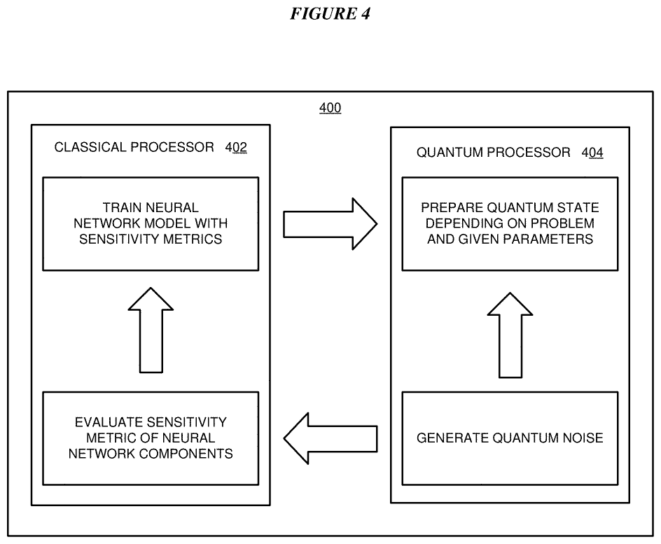

With reference to FIG. 4, this figure depicts a block diagram of an example hybrid quantum/classical system for correcting bias using a classical processor 402 and a quantum processor 404. In the example, classical processor 402 trains a neural network model and sends the neural network model to quantum processor 404.

Quantum processor 404 prepares a quantum state depending on the particular combinatorial problem to be solved and the given update parameters. Quantum processor 404 executes the prepared quantum state and measures the quantum state a multiple number of times to sample from the solution space to generate samples and generate quantum noise. Classical processor 402 receives the quantum noise from quantum processor 404 and evaluates the components of the neural network model to determine sensitivity metrics and if the parameters for the nodes are to be updated.

If classical processor 402 determines that the parameters for the nodes of the neural network model are to be updated, classical processor 402 trains the neural network model with sensitivity metrics to re-train the neural network model. Classical processor 402 then sends the further trained network model to quantum processor 404. Typically, the process is repeated until convergence within an acceptable threshold is obtained.

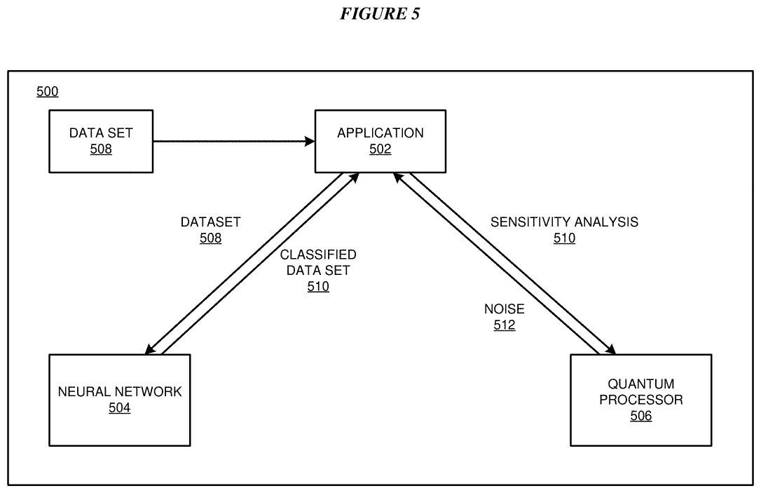

With reference to FIG. 5, this figure depicts a block diagram of an example configuration 500 in accordance with an illustrative embodiment. The example embodiment includes an application 502. In a particular embodiment, application 502 is an example of application 105 of FIG. 1.

Application 502 receives a data set 508. In an embodiment, application 502 provides data set 508 to a neural network 504 for classification. Conventional neural network 504 classifies data set 508 into a set of classified data items 510 according to a classification criterion. For example, neural network 504 can classify a set of images according to an animal depicted in each image.

Application 502 receives the set of classified data items 510 from the neural network 504. In an embodiment, quantum processor 506 generates noise 512. For example, noise 512 can be generated by at least one of swapping qubits in the quantum processor and lengthening pulses in the quantum processor. In an embodiment, the generated noise can affect the classification performed by the neural network 504. For example, neural network 504 can return a new classified data set which may differ from the original classified data set before the noise was introduced to the system.

In an embodiment, application 502 performs a sensitivity analysis on the quantum processor 506. For example, application 502 can compare the original corresponding classification of a data item with the new corresponding classification of the data item to determine a sensitivity of quantum processor 506.

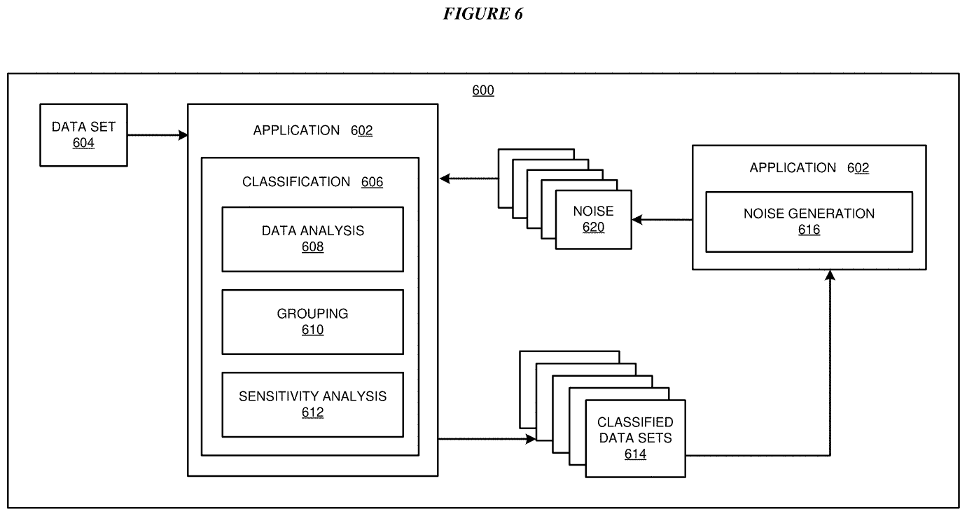

With reference to FIG. 6, this figure depicts a block diagram of an example configuration 600 in accordance with an illustrative embodiment. The example embodiment includes an application 602. In a particular embodiment, application 602 is an example of application 105 of FIG. 1.

Application 602 receives a data set 604. In an embodiment, application 602 includes classification component 606. Classification component 606 classifies data set 604 into a classified data set 614. For example, classification component 606 can classify data set 604 according to characteristics of each data item in data set 604. For example, classification component 604 can classify sounds according to the animal generating the sound. Data analysis component 608 analyzes items in the data set 604. Grouping component 610 groups items in data set 604 into a classified data set 614. In an embodiment, grouping component 610 associates each data item with a corresponding class.

In an embodiment, application 602 includes noise generation component 616. In an embodiment, noise generation component 616 executes on a quantum processor with a quantum memory. Noise generation component 616 generates noise 620 in a data processing environment. For example, noise generation component 616 can generate noise by swapping qubits in the quantum processor. As another example, noise generation component 616 can generate noise 620 by lengthening pulses in the quantum processor.

In an embodiment, classification component 606 reclassifies data set 604 with noise 620 to generate a second classified data set. For example, classification component 606 can associate each data item with a corresponding class. In an embodiment, sensitivity analysis component 616 compares the original class and new class for each data item. For example, the sensitivity analysis component 616 can determine the original class differs from the new class for at least one of the data items. As another example, the sensitivity analysis component 616 can determine none of the original class differ from the new class for any corresponding data item. In an embodiment, sensitivity analysis component 616 determines an overall sensitivity of the quantum processor. For example, sensitivity analysis component 616 can count a number of differentiations between the original class and the new class for the corresponding data items.

These examples of generating noise in a quantum processor are not intended to be limiting. From this disclosure those of ordinary skill in the art will be able to conceive of many other methods suitable for generating noise and the same are contemplated within the scope of the illustrative embodiments.

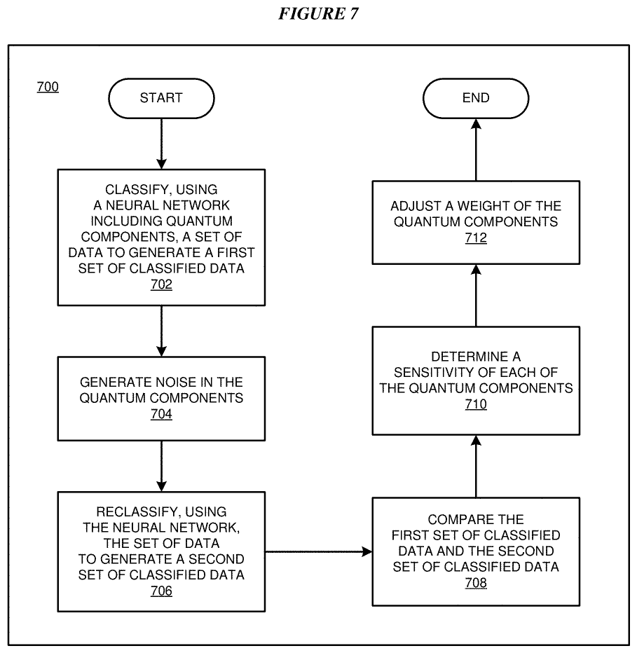

With reference to FIG. 7, this figure depicts a flowchart of an example process in accordance with an illustrative embodiment. In a particular embodiment, application 602 carries out the steps of process 700. At block 702, application 602 classifies a data set to generate a first set of classified data. In an embodiment, application 602 classifies the data set using a neural network including quantum components.

In an embodiment, at block 704 application 602 generates noise in the quantum components. For example, application 602 can generate noise by swapping qubits in a quantum processor. In an embodiment, application 602 generates noise by lengthening pulses in the quantum processor.

In an embodiment, at block 706 application 602 reclassifies the data set to generate a second set of classified data. For example, application 602 can classify the data set with the generated noise. In an embodiment, at block 708 application 602 compares the classification of the first set of classified data and the second set of classified data for each corresponding data item. For example, application 602 can determine whether any classification differs between the first set of classified data and the second set of classified data.

In an embodiment, at block 710 application 602 determines a sensitivity of each of the quantum components in the neural network. In an embodiment, at block 712 application 602 can adjust a weight of the quantum components in the neural network. In an embodiment, process 700 can return to block 702 to classify the data set. Process 700 can continue in this manner until each data item meets a sensitivity criterion. For example, the sensitivity criterion can require a prior classification to match a subset classification for a corresponding data item. Process 700 ends thereafter.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
classifying, using a neural network including quantum components, a data set to generate a first set of classified data;
generating noise in the quantum components;
reclassifying, using the neural network, the data set with the generated noise to generate a second set of classified data;
determining, responsive to comparing the first set of classified data and the second set of classified data, a sensitivity of the quantum components.

2. The method of claim 1, further comprising:
adjusting a weight of the quantum components.

3. The method of claim 2, further comprising:
reclassifying, using the neural network, the data set to generate a third set of classified data.

4. The method of claim 3, further comprising:
determining, responsive to comparing the second set of classified data and the third set of classified data, a sensitivity of the quantum components.

5. The method of claim 4, wherein each classification of the second set of classified data matches each classification of the third set of classified data for each corresponding data item.

6. The method of claim 1, generating noise further comprising:
altering an amplitude of a microwave pulse in a quantum processor.

7. The method of claim 1, generating noise further comprising:
lengthening pulses in a quantum processor.

8. A computer usable program product comprising a computer-readable storage device, and program instructions stored on the storage device, the stored program instructions comprising:
program instructions to classify, using a neural network including quantum components, a data set to generate a first set of classified data;
program instructions to generate noise in the quantum components;
program instructions to reclassify, using the neural network, the data set with the generated noise to generate a second set of classified data; and
program instructions to determine, responsive to comparing the first set of classified data and the second set of classified data, a sensitivity of the quantum components.

9. The computer usable program product of claim 8, wherein the program instructions are stored in a computer readable storage device in a data processing system, and wherein the computer usable code is transferred over a network from a remote data processing system.

10. The computer usable program product of claim 8, wherein the program instructions are stored in a computer readable storage device in a server data processing system, and wherein the computer usable code is downloaded over a network to a remote data processing system for use in a computer readable storage device associated with the remote data processing system.

11. The computer usable program product of claim 8, further comprising:
program instructions to adjust a weight of the quantum components.

12. The computer usable program product of claim 11, further comprising:
program instructions to reclassify, using the neural network, the data set to generate a third set of classified data.

13. The computer usable program product of claim 12, further comprising:
program instructions to determine, responsive to comparing the second set of classified data and the third set of classified data, a sensitivity of the quantum components.

14. The computer usable program product of claim 13, wherein each classification of the second set of classified data matches each classification of the third set of classified data for each corresponding data item.

15. The computer usable program product of claim 8, generating noise further comprising:
program instructions to alter an amplitude of a microwave pulse in a quantum processor.

16. The computer usable program product of claim 8, generating noise further comprising:
program instructions to lengthen pulses in a quantum processor.

17. A computer system comprising a quantum processor, a computer-readable memory, and a computer-readable storage device, and program instructions stored on the storage device for execution by the quantum processor via the memory, the stored program instructions comprising:
program instructions to classify, using a neural network including quantum components, a data set to generate a first set of classified data;
program instructions to generate noise in the quantum components;
program instructions to reclassify, using the neural network, the data set with the generated noise to generate a second set of classified data; and
program instructions to determine, responsive to comparing the first set of classified data and the second set of classified data, a sensitivity of the quantum components.

18. The computer system of claim 17, further comprising:
program instructions to adjust a weight of the quantum components.

19. The computer system of claim 18, further comprising:
program instructions to reclassify, using the neural network, the data set to generate a third set of classified data.

20. The computer system of claim 19, further comprising:
program instructions to determine, responsive to comparing the second set of classified data and the third set of classified data, a sensitivity of the quantum components.
